(19) United States
(12) Patent Application Publication
(10) Pub. No.: US 2021/0049382 A1
(43) Pub. Date: Feb. 18, 2021

(54) NON-LINE OF SIGHT OBSTACLE DETECTION

(71) Applicants: Massachusetts Institute of Technology, Cambridge, MA (US); Toyota Research Institute, Los Altos, CA (US)

(72) Inventors: Felix Maximilian Naser, Cambridge, MA (US); Igor Gilitschenski, Cambridge, MA (US); Alexander Andre Amini, Cambridge, MA (US); Christina Liao, Cambridge, MA (US); Guy Rosman, Newton, MA (US); Sertac Karaman, Cambridge, MA (US); Daniela Rus, Weston, MA (US)

(21) Appl. No.: 17/085,641

(22) Filed: Oct. 30, 2020

Related U.S. Application Data
(63) Continuation-in-part of application No. 16/730,613, filed on Dec. 30, 2019.
Application No. 16/730,613 is a continuation-in-part of application No. 16/179,223, filed on Nov. 2, 2018.
(60) Provisional application No. 62/915,570, filed on Oct. 15, 2019.

(51) Int. Cl. G06K 9/00; G06K 9/62; G06K 9/46; G06T 7/215; G06T 7/11; G05D 1/02

(52) U.S. Cl. CPC G06K 9/00805; G06K 9/6267; G06K 9/4661; G06T 2207/30261; G06T 7/11; G05D 1/0253; G06T 2207/10152; G06T 7/215

(57) ABSTRACT

An object detection method includes receiving sensor data including a number of images associated with a sensor region as the actor traverses an environment, the plurality of images characterizing changes of illumination in the sensor region over time, the sensor region including a region to be traversed by the actor in the future, processing the plurality of images determine a change of illumination in sensor the region over time. The processing includes registering the plurality of images to a common coordinate system based at least in part on odometry data characterizing the actor's traversal of the environment, determining the change of illumination in the sensor region over time based on the registered plurality of images. The method further includes determining an object detection result based at least in part on the change of illumination in the sensor region over time.

### CROSS-REFERENCE TO RELATED APPLICATIONS

This application is a continuation-in-part of U.S. patent application Ser. No. 16/730,613 filed on Dec. 30, 2019 and entitled “INFRASTRUCTURE-FREE NLOS OBSTACLE DETECTION FOR AUTONOMOUS CARS,” which is a continuation-in-part of U.S. patent application Ser. No. 16/179,223 entitled “SYSTEMS AND METHOD OF DETECTING MOVING OBSTACLES” filed on Nov. 2, 2018 and which claims the benefit of U.S. Provisional Patent Application No. 62/915,570 titled “INFRASTRUCTURE FREE NLoS OBSTACLE DETECTINO FOR AUTONOMOUS CARS” filed on Oct. 15, 2019, the disclosures of which are expressly incorporated by reference herein in their entirety.

### BACKGROUND OF THE INVENTION

This invention relates to non-line of sight obstacle detection, and more particularly to such obstacle detection and vehicular applications.

Despite an increase in the number of vehicles on the roads, the number of fatal road accidents has been trending downwards in the United States of America (USA) since 1990. One of the reasons for this trend is the advent of active safety features such as Advanced Driver Assistance Systems (ADAS).

Still, approximately 1.3M fatalities occur due to road accidents annually. Specifically, dangerous are nighttime driving scenarios and almost half of the intersection related crashes are caused due to the driver's inadequate surveillance. Better perception systems and increased situational awareness could help to make driving safer.

Many autonomous navigation technologies such as RADAR, LiDAR, and computer vision-based navigation are well established and are already being deployed in commercial products (e.g., commercial vehicles). While continuing to improve on those well-established technologies, researchers are also exploring how new and alternative uses for the existing technologies of an autonomous system's architecture (e.g. perception, planning, and control) can contribute to safer driving. One example on an alternative use of an existing technology of an autonomous system's architecture is described in Naser, Felix et al. “ShadowCam: Real-Time Detection Of Moving Obstacles Behind A Corner For Autonomous Vehicles.” 21st IEEE International Conference on Intelligent Transportation Systems, 4-7 Nov. 2018, Maui, Hi., United States, IEEE, 2018.

### SUMMARY OF THE INVENTION

Aspects described herein relate to a new and alternative use of a moving vehicle's computer a vision system for detecting dynamic (i.e., moving) objects that are out of a direct line of sight (around a cornet) from the viewpoint of the moving vehicle. Aspects monitor changes in illumination (e.g., changes in shadows or cast light) in a region of interest to infer the presence of out-of-sight objects that cause the changes in illumination.

In a general aspect, an object detection method includes receiving sensor data including a number of images associated with a sensor region as the actor traverses an environment, the number of images characterizing changes of illumination in the sensor region over time, the sensor region including a region to be traversed by the actor in the future, processing the number of images determine a change of illumination in sensor the region over time. The processing includes registering the number of images to a common coordinate system based at least in part on odometry data characterizing the actor's traversal of the environment, determining the change of illumination in the sensor region over time based on the registered number of images. The method further includes determining an object detection result based at least in part on the change of illumination in the sensor region over time.

Aspects may include one or more of the following features.

The odometry data may be determined using a visual odometry method. The visual odometry method may be a direct-sparse odometry method. The change of illumination in the sensor region over time may be due to a shadow cast by an object. The object may not be visible to the sensor in the sensor region. Processing the number of images may includes determining homographies for transforming at least some of the images to a common coordinate system. Registering the number of images may include using the homographies to warp the at least some images into the common coordinate system.

Determining the change of illumination in the sensor region over time may include determining a score characterizing the change of illumination in the sensor region over time. Determining the object detection result may include comparing the score to a predetermined threshold. The object detection result may indicate that an object is detected if the score is equal to or exceeds the predetermined threshold and the object detection result may indicate that no object is detected if the score does not exceed the predetermined threshold.

Determining the change of illumination in the sensor region over time may further include performing a color amplification procedure on the number of registered images. Determining the change of illumination in the sensor region over time may further include applying a low-pass filter to the number of color amplified images. Determining the change of illumination in the sensor region over time may further include applying a threshold to pixels of the number of images to classify the pixels as either changing over time or remaining static over time. Determining the change of illumination in the sensor region over time may further include performing a morphological filtering operation on the pixels of the images. Determining the change of illumination in the sensor region over time may further include generating a score characterizing the change of illumination in the sensor region over time including summing the morphologically filtered pixels of the images.

The common coordinate system may be a coordinate system is a coordinate system associated with a first image of the number of images. The method may include providing the object detection result to an interface associated with the actor. The sensor may include a camera. The actor may include a vehicle. The vehicle may be an autonomous vehicle.

In another general aspect, software embodied on a non-transitory computer readable medium includes instructions for causing one or more processors to receive sensor data including a number of images associated with a sensor region as the actor traverses an environment, the number of images characterizing changes of illumination in the sensor region over time, the sensor region including a region to be traversed by the actor in the future and process the number of images determine a change of illumination in sensor the region over time. The processing includes registering the number of images to a common coordinate system based at least in part on odometry data characterizing the actor's traversal of the environment, determining the change of illumination in the sensor region over time based on the registered number of images, and determining an object detection result based at least in part on the change of illumination in the sensor region over time.

In another general aspect, an object detection system includes an input for receiving sensor data including a number of images associated with a sensor region as the actor traverses an environment, the number of images characterizing changes of illumination in the sensor region over time, the sensor region including a region to be traversed by the actor in the future, one or more processors for processing the number of images determine a change of illumination in sensor the region over time. The processing includes registering the number of images to a common coordinate system based at least in part on odometry data characterizing the actor's traversal of the environment, determining the change of illumination in the sensor region over time based on the registered number of images. The system includes a classifier for determining an object detection result based at least in part on the change of illumination in the sensor region over time.

Aspects may have one or more of the following advantages.

Among other advantages, aspects described herein are able to detect non-line of sight objects even under nighttime driving conditions based on shadows and illumination cues. Aspects are advantageously able to detect obstacles behind buildings or parked cars and thus help to prevent collisions.

Unlike current sensor solutions (e.g. LiDAR, RADAR, ultrasonic, cameras, etc.) and algorithms widely used in ADAS applications, aspects described herein advantageously do not require a direct line of sight in order to detect and/or classify dynamic obstacles.

Aspects may advantageously include algorithms which run fully integrated on autonomous car. Aspects also advantageously do not rely on fiducials or other markers on travel ways (e.g., AprilTags). Aspects advantageously operate even at night and can detect approaching vehicles or obstacles based on one or both of lights cast by the vehicles/obstacles (e.g., headlights) and shadows cast by the vehicles/obstacles before conventional sensor systems (e.g. a LiDAR) can detect the vehicles/objects.

Aspects advantageously do not rely on any infrastructure, hardware, or material assumptions. Aspects advantageously use a visual odometry technique that performs reliably in hallways and areas where only very few textural features exist.

Aspects advantageously increase safety by increasing the situational awareness of a human driver when used as an additional ADAS or of the autonomous vehicle when used as an additional perception module. Aspects therefore advantageously enable the human driver or the autonomous vehicle to avoid potential collisions with dynamic obstacles out of the direct line of sight at day and nighttime driving conditions.

In contrast to conventional taillight detection approaches, which are rule-based or learning-based, aspects advantageously do not require direct sight of the other vehicle to detect the vehicle

Other features and advantages of the invention are apparent from the following description, and from the claims.

### BRIEF DESCRIPTION OF THE DRAWINGS

FIG. 1A shows a pedestrian and a vehicle both approaching an intersection.

FIG. 1B shows the pedestrian and the vehicle of FIG. 1A closer to the intersection, with the pedestrian's shadow intersecting with a sensor region of the vehicle.

FIG. 2 is an object detection system.

FIG. 3 is visual odometry-based image registration algorithm.

FIG. 4 is an image pre-processing algorithm.

FIG. 5 is a classification algorithm.

FIG. 6A shows a first vehicle and a second vehicle both approaching an intersection.

FIG. 6B shows the first and second vehicles of FIG. 6A both closer to the intersection, with the second vehicle's headlights intersecting with a sensor region of the first vehicle.

### DETAILED DESCRIPTION

### 1 Overview

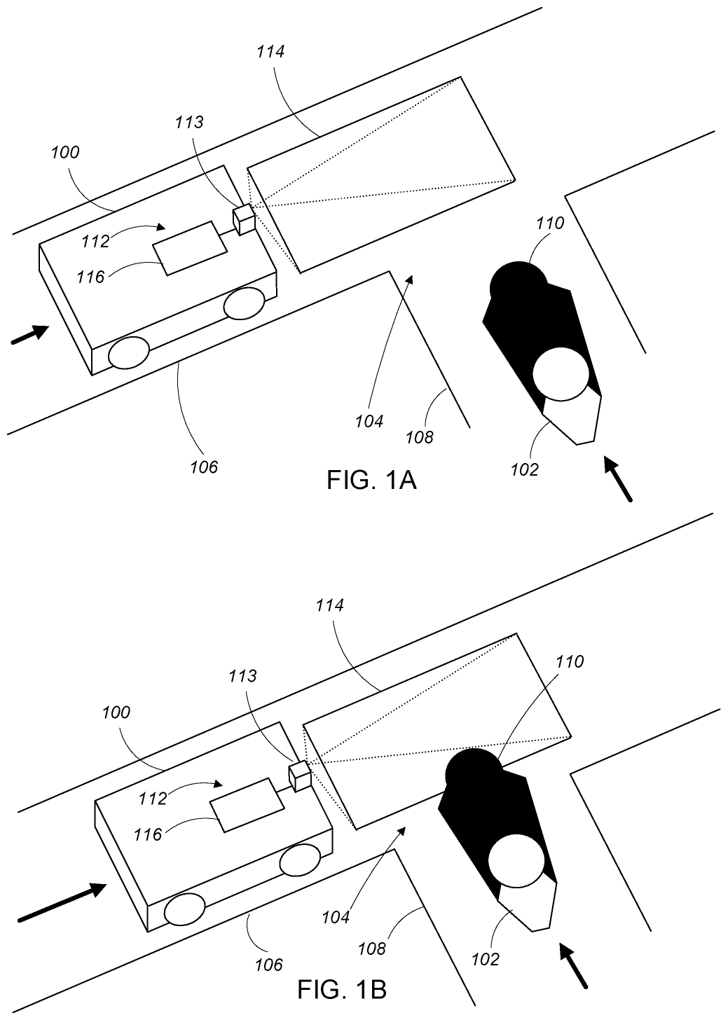

Referring to FIGS. 1A and 1B, two objects (in this case a vehicle 100 and a pedestrian 102) are each approaching an intersection 104 of two paths 106, 108 (e.g., roads or hallways). The pedestrian 102 casts a shadow 110 in a direction toward the intersection 104 such that the shadow reaches the intersection prior to the pedestrian physically reaching the intersection (i.e., the shadow “leads” the pedestrian). The vehicle 100 includes an obstacle detection system 112, which includes a sensor 113 (e.g., a camera) and a sensor data processor 116. Very generally, the obstacle detection system 112 is configured to detect dynamic (i.e., moving) obstacles that are out of the direct line-of-sight from the viewpoint of the moving vehicle 100 based on changes in illumination (e.g., moving shadows or moving illumination) that are or become present in the direct line-of-sight of the vehicle as it travels along its path. The vehicle may then take action (e.g., evasive action) based on the detected objects.

To detect such out-of-sight objects, the sensor 113 captures data (e.g., video frames) associated with a sensor region 114 in front of the vehicle 100. The sensor data processor 116 processes the sensor data to identify any changes in illumination at particular physical locations (i.e., at locations in the fixed physical reference frame as opposed to a moving reference frame) that are indicative of an obstacle that is approaching the path of the vehicle 100 but is not directly visible to the sensor 113. The obstacle detection system 112 generates a detection output that is used by the vehicle 100 to avoid collisions or other unwanted interactions with any identified obstacle that is approaching the path of the vehicle 100.

For example, in FIG. 1A, both the vehicle 100 and the pedestrian 102 are approaching the intersection 104 and the pedestrian's shadow 110 has not yet reached the sensor region 114. The obstacle detection system 112 monitors the illumination in the sensor region 114 (or a part of the sensor region) and does not yet detect any change in illumination indicating that an obstacle is approaching the path of the vehicle 100 (due to the shadow not intersecting with the sensor region 114). The obstacle detection system 112 therefore provides a detection output to the vehicle 100 indicating that it is safe for the vehicle to continue traveling along its path 106.

In FIG. 1B, both the vehicle 100 and the pedestrian 102 have traveled further along their respective paths 106, 108 such that the pedestrian's shadow 110 intersects with the vehicle's sensor region 114. As is described in greater detail below, the object detection system 112 detects a change in illumination in a region of the intersection within the sensor region 114 that is indicative of an obstacle that is approaching the path 106 of the vehicle 100. The object detection system 112 provides an output to the vehicle 100 indicating that it may be unsafe for the vehicle to continue traveling along its path 106. The output is provided to a vehicle interface (not shown) of the vehicle 100, which takes an appropriate action (e.g., stopping the vehicle).

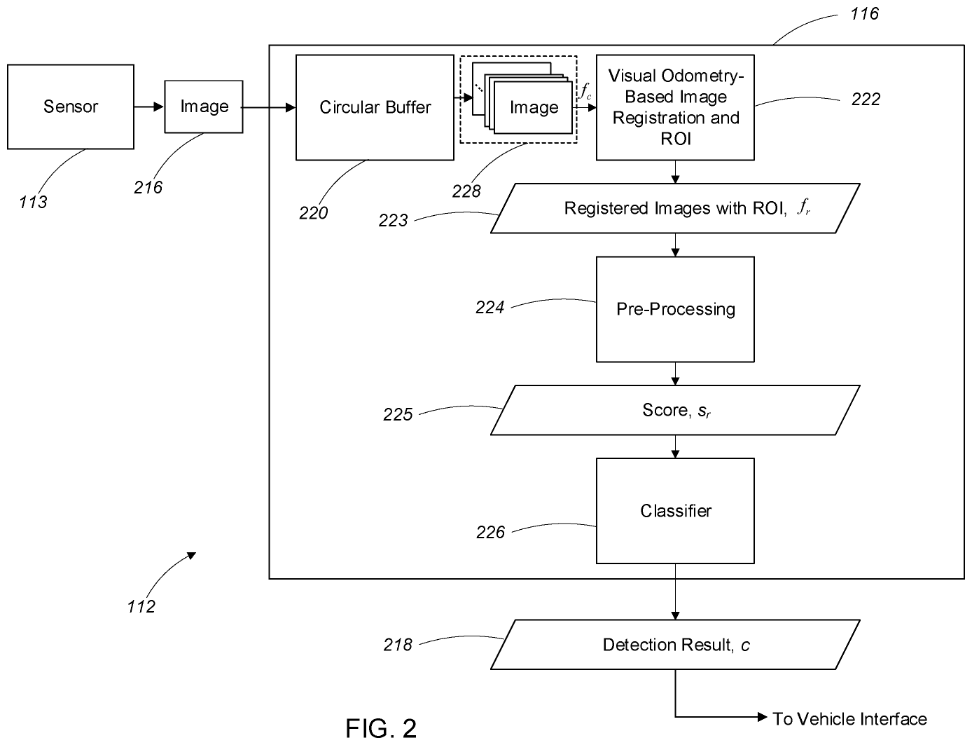

Referring to FIG. 2, in operation of the object detection system 112, the sensor 113 generates successive images 216, which are in turn provided to the sensor data processor 116. Note that because the vehicle is moving, each image 216 is acquired for a different point of view. The sensor data processor 116 processes the new image 216 to generate a detection result, c 218 that is provided to a vehicle interface.

The sensor data processor 116 includes a circular buffer 220, a visual odometry-based image registration and region of interest (ROI) module 222, a pre-processing module 224, and a classifier 226.

### 2 Circular Buffer

Each image 216 acquired by the sensor 113 is first provided to the circular buffer 220, which stores a most recent sequence of images from the sensor 113. In some examples, the circular buffer 220 maintains a pointer to an oldest image stored in the buffer. When the new image 216 is received, the pointer is accessed, and the oldest image stored at the pointer location is overwritten with the new image 216. The pointer is then updated to point to the previously second oldest image. Of course, other types of buffers such as FIFO buffers can be used to store the most recent sequence of images, so long as they are able to achieve near time or near real-time performance.

With the new image 216 stored in the circular buffer 220, the circular buffer 220 outputs a most recent sequence of images, f_{c} 228.

### 3 Visual Odometry-Based Image Registration and ROI

The most recent sequence of images, f_{c} 228 is provided to the visual odometry-based image registration and ROI module 222, which registers the images in the sequence of images to a common viewpoint (i.e., projects the images to a common coordinate system) using a visual odometry-based registration method. A region of interest (ROI) is then identified in the registered images. The output of the visual odometry-based image registration and ROI module 222 is a sequence of registered images with a region of interest identified, fᵣ 223.

As is described in greater detail below, in some examples, the visual odometry-based image registration and ROI module executes an algorithm that registers the images to a common viewpoint using a direct sparse odometry (DSO) technique. Very generally, DSO maintains a ‘point cloud’ of three-dimensional points encountered in a world as an actor traverses the world. This point cloud is sometimes referred to as the ‘worldframe’ view.

For each image in the sequence of images 228, DSO computes a pose M_{w}^{c} including a rotation matrix, R and a translation vector t in a common (but arbitrary) frame of reference for the sequence 228. The pose represents the rotation and translation of a camera used to capture the image relative to the worldview.

The poses for each of the images are then used to compute homagraphies, H, which are in turn used to register each image to a common viewpoint such as a viewpoint of a first image of the sequence of images (e.g., the new image 216), as is described in greater detail below. In general, each of the homagraphies, H is proportional to information given by the planar surface equation, the rotation matrix, R, and the translation vector t between two images:

H∝R−tn^{T}

where n designates the normal of the local planar approximation of a scene.

Very generally, having established a common point of view of the “world,” the approach identifies a “ground plane” in the world, for example, corresponding to the surface of a roadway or the floor of a hallway, and processes the images passed on the ground plane.

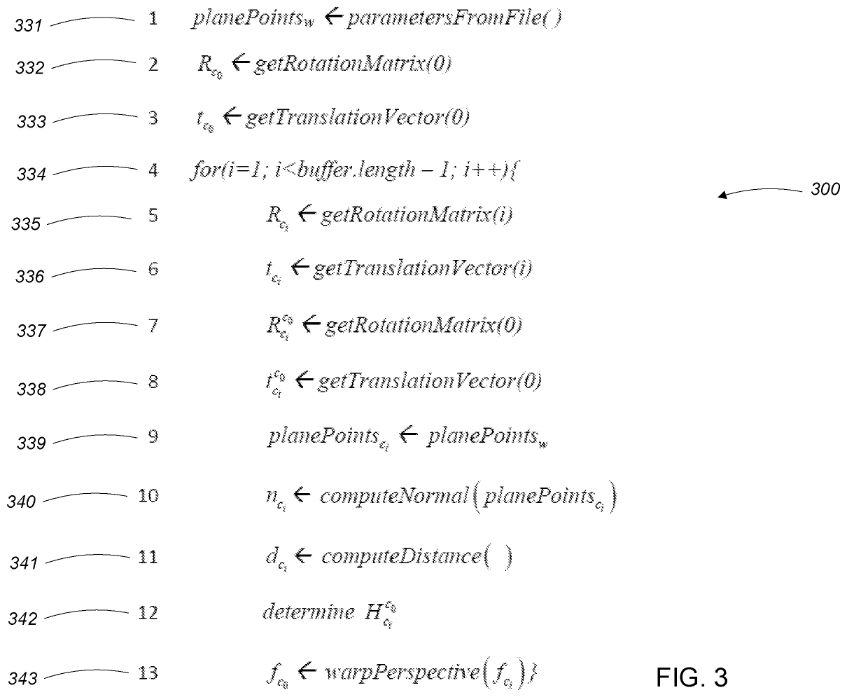

Referring to FIG. 3, in a first step 331 at line 1 of the algorithm 300 executed by the visual odometry-based image registration and ROI module 222, “planePoints_{w}” parameters are read from file. The planePoints_{w} parameters include a number (e.g., three) of points that were previously annotated (e.g., by hand annotation) on the ground plane in the worldframe view, w. DSO uses the planePoints_{w} parameters to establish the ground plane in the worldframe view, w.

In second and third steps 332, 333 steps at lines 2 and 3 of the algorithm 300, a pose M_{c}_{₀}^{w} for the first image, f₀ in the sequence of images 228 (i.e., a transformation from camera view, c₀ for the first image, f₀ in the sequence of images 228 into the worldframe view, w) is determined using DSO. The second step 332 determines a rotation matrix, R_{c}_{₀}^{w} for the pose M_{c}_{₀}^{w} and the third step 333 determines a translation vector, t_{c}_{₀} for the pose M_{c}_{₀}^{w}.

In a fourth step 334 at line 4 of the algorithm 300, a for loop is initiated for iterating through the remaining images of the sequence of images 228. For each iteration, i of the for loop, the i^{th} image of the sequence of images 228 is processed using fifth through fourteenth steps of the algorithm 300.

In the fifth 335 and sixth 336 steps at lines 5 and 6 of the algorithm 300, a pose, M_{c}_{ᵢ}^{w} for the i^{th} image, fᵢ in the sequence of images 228 (i.e., a transformation from camera view cᵢ for the i^{th} image, fᵢ in the sequence of images 228 into the worldframe view, w) is determined using DSO. The fifth step 335 determines a rotation matrix, R_{c}_{ᵢ}^{w} for the pose M_{c}_{ᵢ}^{w} and the sixth step 336 determines a translation vector, t_{c}_{ᵢ} for the pose M_{c}_{ᵢ}^{w}.

In the seventh and eighth steps 337, 338 at lines 7 and 8 of the algorithm 300, a transformation, M_{c}_{ᵢ}^{c}^{₀} from camera view cᵢ for the i^{th} image, fᵢ in the sequence of images to the camera view, c₀ for the first image, f₀ in the sequence of images is determined using DSO. The seventh step 337 determines a rotation matrix, R_{c}_{ᵢ}^{c}^{₀} for the transformation M_{c}_{ᵢ}^{c}^{₀} and the eighth step 338 determines a translation vector, t_{c}_{ᵢ}^{c}^{₀} for the transformation M_{c}_{ᵢ}^{c}^{₀}. In some examples, M_{c}_{ᵢ}^{c}^{₀} is determined as follows:

$${M}_{{C}_{i}}^{{c}_{0}} = {M}_{w}^{{c}_{0}} \cdot {( {M}_{w}^{{c}_{i}} )}^{- 1} = [ \begin{matrix}{R}_{w}^{{c}_{2}} & {t}_{w}^{{c}_{2}} \\ {0}_{3 \times 1} & 1\end{matrix} ] \cdot [ \begin{matrix}( {R}_{w}^{{c}_{1}} {)}^{T} & - {( {R}_{w}^{{c}_{1}} )}^{T} \cdot {t}_{w}^{{c}_{1}} \\ {0}_{3 \times 1} & 1\end{matrix} ]$$

where the rotation matrix R_{c}_{ᵢ}^{c}^{₀} is specified as:

R_{c}_{ᵢ}^{c}^{₀}=R_{w}^{c}^{₀}·(R_{w}^{c}^{ᵢ})^{T}

and the translation vector t_{c}_{ᵢ}^{c}^{₀} is specified as:

t_{c}_{ᵢ}^{c}^{₀}=R_{w}^{c}^{₀}·(−(R_{w}^{c}^{ᵢ})^{T}·t_{w}^{c}^{ᵢ})+t_{w}^{c}^{₀}.

In the ninth step 339 at line 9 of the algorithm 300, the planePoints_{w} parameters are transformed from the worldframe view, w to the viewpoint of the camera in the i^{th} image, cᵢ using the following transformation:

$$[ \begin{matrix}{X}_{{c}_{i}} \\ {Y}_{{c}_{i}} \\ {Z}_{{c}_{i}} \\ 1\end{matrix} ] = {M}_{w}^{{c}_{i}} [ \begin{matrix}{X}_{w} \\ {Y}_{w} \\ {Z}_{w} \\ 1\end{matrix} ] = [ \begin{matrix}{R}_{w}^{{c}_{i}} & {t}_{w}^{{c}_{i}} \\ {0}_{1 \times 3} & 1\end{matrix} ] [ \begin{matrix}{X}_{w} \\ {Y}_{w} \\ {Z}_{w} \\ 1\end{matrix} ]$$

In the tenth step 340 at line 10 of the algorithm 300, the result of the transformation of the ninth step 339, planePoints_{c}_{ᵢ} is processed in a computeNormal( ) function to obtain the ground plane normal, n_{c}_{ᵢ} for the image, fᵢ.

In the eleventh step 341 at line 11 of the algorithm 300, the distance, d_{c}_{ᵢ} of the camera from the ground plane in the i^{th} image, fᵢ is determined as a dot product between the plane normal, n_{c}_{ᵢ} for the i^{th} image, fᵢ and a point on the ground plane using the computeDistance( ) function.

In the twelfth step 342 at line 12 of the algorithm 300, the homography matrix, H_{c}_{ᵢ}^{c}^{₀} for transforming the i^{th} image, fᵢ to the common viewpoint of the first image, f₀ is determined as:

$${H}_{{c}_{i}}^{{c}_{0}} = {R}_{{c}_{i}}^{{c}_{0}} - \frac{{t}_{{c}_{i}}^{{c}_{0}} \cdot {( {n}_{{c}_{i}} )}^{T}}{{d}_{{c}_{i}}}$$

Finally, in the thirteenth step 343 at line 13 of the algorithm 300, a warpPerspective( ) function is used to compute a warped version of the the i^{th} image, f_{r,i} by warping the perspective of the first image, f₀ using the homography matrix, H_{c}_{ᵢ}^{c}^{₀} as follows:

$${f}_{r , i} = s [ \begin{matrix}u \\ v \\ 1\end{matrix} ] = {KH}_{{c}_{i}}^{{c}_{0}} [ \begin{matrix}{X}_{w} \\ {Y}_{w} \\ {Z}_{w} \\ 1\end{matrix} ] = [ \begin{matrix}{f}_{x} & 0 & {c}_{ix} \\ 0 & {f}_{y} & {c}_{iy} \\ 0 & 0 & 1\end{matrix} ] [ \begin{matrix}{r}_{11} & {r}_{12} & {r}_{13} & {t}_{ix} \\ {r}_{21} & {r}_{22} & {r}_{23} & {t}_{iy} \\ {r}_{31} & {r}_{32} & {r}_{33} & {t}_{iz}\end{matrix} ] [ \begin{matrix}{X}_{w} \\ {Y}_{w} \\ {Z}_{w} \\ 1\end{matrix} ] ,$$

where K is the camera's intrinsic matrix.

With the images of the sequence of images 228 registered to a common viewpoint, a region of interest (e.g., a region where a shadow is likely to appear) in each of the images is identified and the sequence of registered images with the region of interest identified is output as, fᵣ. In some examples, the region of interest is hand annotated (e.g., an operator annotates the image(s)). In other examples, the region of interest is determined using one or more of maps, place-recognition, and machine learning techniques.

### 4 Pre-Processing

Referring again to FIG. 2, the sequence of registered images with the region of interest identified, fᵣ 223 is provided to the pre-processing module 224 which processes the sequence of images generate a score, sᵣ characterizing an extent to which illumination changes over the sequence of images.

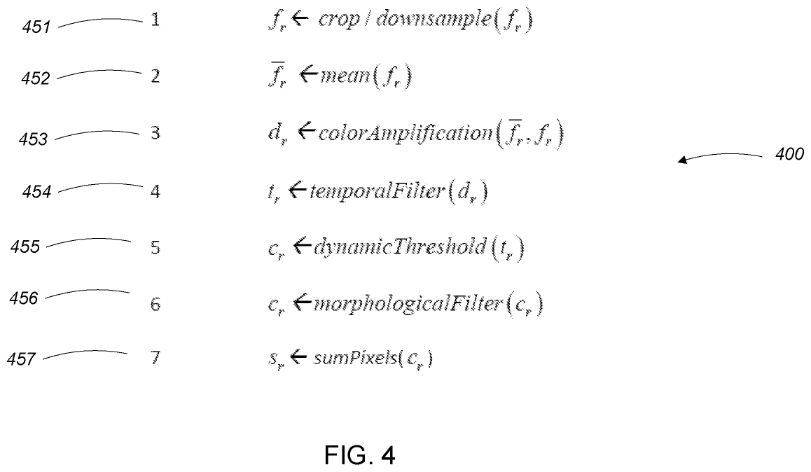

Referring to FIG. 4, a pre-processing algorithm 400 includes a number of steps for processing the sequence of registered images with the region of interest identified, fᵣ 223 to generate the score, sᵣ.

In a first step 451 at line 1 of the pre-processing algorithm 400, the registered images, fᵣ are processed by a crop/downsample( ) function, which crops the images according to the region of interest and down samples the cropped images (e.g., using a bilinear interpolation technique) to, for example, a 100×100 pixel image.

In a second step 452 at line 2 of the pre-processing algorithm 400, the down sampled images are processed in a mean( ) function, which computes a mean image over all of the down-sampled images as:

$$\overline{{f}_{r}} = \frac{1}{n} {\sum }_{i = 0}^{n - 1} {f}_{r , i}$$

In a third step 453 at line 3 of the pre-processing algorithm 400, the down-sampled images, fᵣ and the mean image, f̅ᵣ are color amplified using a colorAmplification( ) function to generate a sequence of color amplified images, d_{r,i}. In some examples, color amplification first subtracts the mean image, f̅ᵣ from each of the registered, down sampled images. Then, a Gaussian blur is applied to the result as follows:

d_{r,i}=|G((f_{r,i}−f̅ᵣ), k, σ)|·α.

In some examples, G is a linear blur filter of size k using isotropic Gaussian kernels with covariance matrix diag (σ², σ²), where the parameter σ is determined from k as σ=0.3·((k−1)0.5−1)+0.8. The parameter α configures the amplification of the difference to the mean image. This color amplification process helps to improve the detectability of a shadow (sometimes even if the original signal is invisible to the human eye) by increasing the signal-to-noise ratio.

In a fourth step 454 at line 4 of the pre-processing algorithm 400, the sequence of color amplified images, d_{r,i} is then temporally low-pass filtered to generate a sequence of filtered images, tᵣ as follows:

t_{r,i}=d_{r,i}·t+d_{r,i-1}·(1−t)

where t_{r,i} is the filtered result of the color amplified images d_{r,i} .

In a fifth step 455 at line 5 of the pre-processing algorithm, a “dynamic” threshold is applied, on a pixel-by-pixel basis, to the filtered images tᵣ to generate images with classified pixels, cᵣ. In some examples, the images with classified pixels, cᵣ include a classification of each pixel of each image as being either “dynamic” or “static” based on changes in illumination in the pixels of the images. To generate the images with classified pixels, cᵣ a difference from the mean of each pixel of the filtered images is used as a criterion to determine a motion classification with respect to the standard deviation of the filtered image as follows:

$${c}_{r , i} = \{ \begin{matrix}0 , & ∀ \vert {t}_{r , i} - \overline{{t}_{r , i}} \vert \leq w \cdot σ ( {t}_{r , i} ) \\ 1 , & ∀ \vert {t}_{r , i} - \overline{{t}_{r , i}} \vert > w \cdot σ ( {t}_{r , i} )\end{matrix}$$

where w is a tune-able parameter that depends on the noise distribution. In some examples, w is set to 2. The underlying assumption is that dynamic pixels are further away from the mean since they change more drastically. So, any pixels that are determined to be closer to the mean (i.e., by not exceeding the threshold) are marked with the value ‘0’ (i.e., classified as a “static” pixel). Any pixels that are determined to be further from the mean are marked with the value ‘1’ (i.e., classified as a “dynamic” pixel).

In a sixth step 456 at line 6 of the pre-processing algorithm 400, a morphologicalFilter( ) function is applied to the classified pixels for each image, c_{r,i} including applying a dilation to first connect pixels of the image which were classified as motion and then applying an erosion to reduce noise. In some examples, this is accomplished by applying morphological ellipse elements with two different kernel sizes, e.g.,

c_{r,i}=dilate(c_{r,i},1),

c_{r,i}=erode(c_{r,i},3).

In a seventh step 456 at line 7 of the pre-processing algorithm 400, The output of the sixth step 456 for each of the images, c_{r,i} is summed, classified pixel-by-classified pixel as follows:

$${s}_{r} = {\sum }_{i = 0}^{n - 1} {c}_{r , i} ( x , y )$$

The intuitive assumption is that that more movement in between frames will result in a higher sum. Referring again to FIG. 2, the sum is output from the pre-processing module 224 as the score, sᵣ 225.

### 5 Classifier

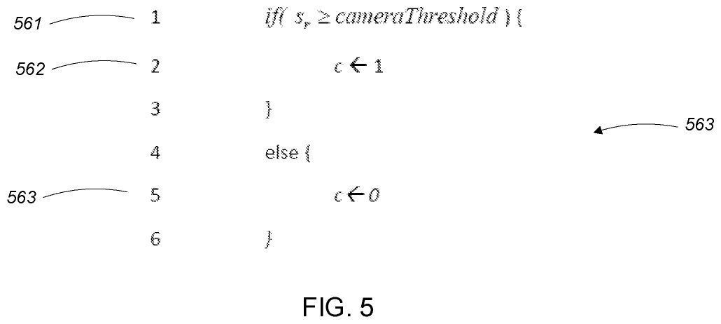

Referring to FIG. 5, the classifier 224 receives the score, sᵣ from the pre-processing module 224 and uses a classification algorithm 500 to compares the score to a predetermined, camera-specific threshold, T to determine the detection result, c 218.

In a first step 561 at line 1 of the classification algorithm 500, the score, sᵣ is compared to the camera-specific threshold, T.

In a second step 562 at line 2 of the classification algorithm 500, if the score, sᵣ is greater than or equal to the camera-specific threshold, T then the classifier 226 outputs a detection result, c 218 indicating that the sequence of images, f_{c} is “dynamic” and an obstacle is approaching the path of the vehicle 100.

Otherwise, in a third step 563 at line 5 of the classification algorithm, if the score, sᵣ does not exceed the threshold, T, then the classifier 226 outputs a detection result, c 218 indicating that the sequence of images, f_{c} is “static” and no obstacle is approaching the path of the vehicle 100. In some examples, the detection result, c 218 indicates whether it is safe for the vehicle 100 to continue along its path.

The detection result, c 218 is provided to the vehicle interface, which uses the detection result, c 218 to control the vehicle 100 (e.g., to prevent collisions between the vehicle and obstacles). In some examples, the vehicle interface temporally filters on the detection results to further smooth the signal.

### 6 Vehicle Headlight Detection Example

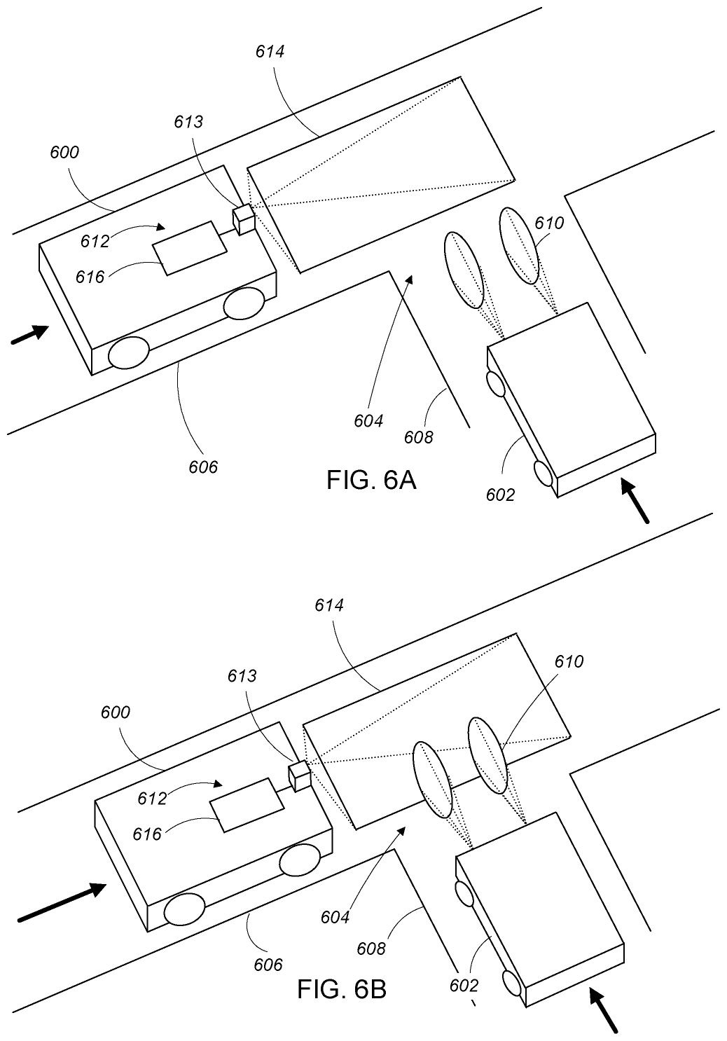

Referring to FIGS. 6A and 6B, in another example where the approaches described above are used, two objects (in this case a first vehicle 600 and a second vehicle 602) are each approaching an intersection 604 of two paths 606, 608 (e.g., roads). The second vehicle 602 has its headlights on, which project light 610 in a direction toward the intersection 604 such that the light reaches the intersection prior to the second vehicle 602 physically reaching the intersection (i.e., the light “leads” the second vehicle).

As was the case in FIGS. 1A and 1B, the first vehicle 600 includes an obstacle detection system 612, which includes a sensor 613 (e.g., a camera) and a sensor data processor 616. Very generally, the obstacle detection system 612 is configured to detect dynamic (i.e., moving) obstacles that are out of the direct line-of-sight from the viewpoint of the moving first vehicle 600 based on changes in illumination (e.g., moving illumination) that are or become present in the direct line-of-sight of the vehicle as it travels along its path. The vehicle may then take action (e.g., evasive action) based on the detected objects.

To detect such out-of-sight objects, the sensor 613 captures data (e.g., video frames) associated with a sensor region 614 in front of the first vehicle 600. The sensor data processor 616 processes the sensor data to identify any changes in illumination at particular physical locations (i.e., at locations in the fixed physical reference frame as opposed to a moving reference frame) that are indicative of an obstacle that is approaching the path of the vehicle 600 but is not directly visible to the sensor 613. The obstacle detection system 612 generates a detection output that is used by the vehicle 600 to avoid collisions or other unwanted interactions with any identified obstacle that is approaching the path of the vehicle 600.

For example, in FIG. 6A, both the first vehicle 600 and the second vehicle 602 are approaching the intersection 604 and the light 610 projected by the second vehicle's headlights has not yet reached the sensor region 614. The obstacle detection system 612 monitors the illumination in the sensor region 614 (or a part of the sensor region) and does not yet detect any change in illumination indicating that an obstacle is approaching the path of the vehicle 600 (due to the light not intersecting with the sensor region 614). The obstacle detection system 612 therefore provides a detection output to the vehicle 600 indicating that it is safe for the first vehicle to continue traveling along its path 606.

In FIG. 6B, both the first vehicle 600 and the second vehicle 602 have traveled further along their respective paths 606, 608 such that the light 610 projected by the second vehicle's headlights intersects with the first vehicle's sensor region 614. As is described in greater detail above, the object detection system 612 detects a change in illumination in a region of the intersection within the sensor region 614 that is indicative of an obstacle that is approaching the path 606 of the first vehicle 600. The object detection system 612 provides an output to the first vehicle 600 indicating that it may be unsafe for it to continue traveling along its path 606. The output is provided to a vehicle interface (not shown) of the first vehicle 600, which takes an appropriate action (e.g., stopping the vehicle).

### 7 Alternatives

While the examples described above are described in the context of a vehicle such as an automobile and a pedestrian approaching an intersection, other contexts are possible. For example, the system could be used by an automobile to detect other automobiles approaching an intersection. Alternatively, the system could be used by other types of vehicles such as wheelchairs or autonomous robots to detect non-line of sight objects.

In the examples described above, detection of shadows intersecting with a region of interest is used to detect non-line of sight objects approaching an intersection. But the opposite is possible as well, where an increase in illumination due to, for example, approaching headlights is used to detect non-line of sight objects approaching an intersection (e.g., at night)

In some examples, some of the modules (e.g., registration, pre-processing, and/or classification) described above are implemented using machine learning techniques such as neural networks.

In some examples, other types of odometry (e.g., dead reckoning) are used instead of or in addition to visual odometry in the algorithms described above.

### 8 Implementations

The approaches described above can be implemented, for example, using a programmable computing system executing suitable software instructions or it can be implemented in suitable hardware such as a field-programmable gate array (FPGA) or in some hybrid form. For example, in a programmed approach the software may include procedures in one or more computer programs that execute on one or more programmed or programmable computing system (which may be of various architectures such as distributed, client/server, or grid) each including at least one processor, at least one data storage system (including volatile and/or non-volatile memory and/or storage elements), at least one user interface (for receiving input using at least one input device or port, and for providing output using at least one output device or port). The software may include one or more modules of a larger program. The modules of the program can be implemented as data structures or other organized data conforming to a data model stored in a data repository.

The software may be stored in non-transitory form, such as being embodied in a volatile or non-volatile storage medium, or any other non-transitory medium, using a physical property of the medium (e.g., surface pits and lands, magnetic domains, or electrical charge) for a period of time (e.g., the time between refresh periods of a dynamic memory device such as a dynamic RAM). In preparation for loading the instructions, the software may be provided on a tangible, non-transitory medium, such as a CD-ROM or other computer-readable medium (e.g., readable by a general or special purpose computing system or device), or may be delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FPGAs) or dedicated, application-specific integrated circuits (ASICs). The processing may be implemented in a distributed manner in which different parts of the computation specified by the software are performed by different computing elements. Each such computer program is preferably stored on or downloaded to a computer-readable storage medium (e.g., solid state memory or media, or magnetic or optical media) of a storage device accessible by a general or special purpose programmable computer, for configuring and operating the computer when the storage device medium is read by the computer to perform the processing described herein. The system may also be considered to be implemented as a tangible, non-transitory medium, configured with a computer program, where the medium so configured causes a computer to operate in a specific and predefined manner to perform one or more of the processing steps described herein.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

What is claimed is:

1. An object detection method comprising:
receiving sensor data including a plurality of images associated with a sensor region as the actor traverses an environment, the plurality of images characterizing changes of illumination in the sensor region over time, the sensor region including a region to be traversed by the actor in the future;
processing the plurality of images determine a change of illumination in sensor the region over time, the processing including:
registering the plurality of images to a common coordinate system based at least in part on odometry data characterizing the actor's traversal of the environment; and
determining the change of illumination in the sensor region over time based on the registered plurality of images; and
determining an object detection result based at least in part on the change of illumination in the sensor region over time.

2. The method of claim 1 wherein the odometry data is determined using a visual odometry method.

3. The method of claim 2 wherein the visual odometry method is a direct-sparse odometry method.

4. The method of claim 1 wherein the change of illumination in the sensor region over time is due to a shadow cast by an object.

5. The method of claim 4 wherein the object is not visible to the sensor in the sensor region.

6. The method of claim 1 wherein processing the plurality of images further includes determining homographies for transforming at least some of the images to a common coordinate system.

7. The method of claim 6 wherein registering the plurality of images includes using the homographies to warp the at least some images into the common coordinate system.

8. The method of claim 1 wherein determining the change of illumination in the sensor region over time includes determining a score characterizing the change of illumination in the sensor region over time.

9. The method of claim 8 wherein determining the object detection result includes comparing the score to a predetermined threshold.

10. The method of claim 9 wherein the object detection result indicates that an object is detected if the score is equal to or exceeds the predetermined threshold and the object detection result indicates that no object is detected if the score does not exceed the predetermined threshold.

11. The method of claim 1 wherein determining the change of illumination in the sensor region over time further includes performing a color amplification procedure on the plurality of registered images.

12. The method of claim 11 wherein determining the change of illumination in the sensor region over time further includes applying a low-pass filter to the plurality of color amplified images.

13. The method of claim 12 wherein determining the change of illumination in the sensor region over time further includes applying a threshold to pixels of the plurality of images to classify the pixels as either changing over time or remaining static over time.

14. The method of claim 13 wherein determining the change of illumination in the sensor region over time further includes performing a morphological filtering operation on the pixels of the images.

15. The method of claim 14 wherein determining the change of illumination in the sensor region over time further includes generating a score characterizing the change of illumination in the sensor region over time including summing the morphologically filtered pixels of the images.

16. The method of claim 1 wherein the common coordinate system is a coordinate system is a coordinate system associated with a first image of the plurality of images.

17. The method of claim 1 further comprising providing the object detection result to an interface associated with the actor.

18. The method of claim 1 wherein the sensor includes a camera.

19. The method of claim 1 wherein the actor includes a vehicle.

20. The method of claim 19 wherein the vehicle is an autonomous vehicle.

21. Software embodied on a non-transitory computer readable medium, the software including instructions for causing one or more processors to:
receive sensor data including a plurality of images associated with a sensor region as the actor traverses an environment, the plurality of images characterizing changes of illumination in the sensor region over time, the sensor region including a region to be traversed by the actor in the future;
process the plurality of images determine a change of illumination in sensor the region over time, the processing including:
registering the plurality of images to a common coordinate system based at least in part on odometry data characterizing the actor's traversal of the environment;
determining the change of illumination in the sensor region over time based on the registered plurality of images; and
determine an object detection result based at least in part on the change of illumination in the sensor region over time.

22. An object detection system comprising:
an input for receiving sensor data including a plurality of images associated with a sensor region as the actor traverses an environment, the plurality of images characterizing changes of illumination in the sensor region over time, the sensor region including a region to be traversed by the actor in the future;
one or more processors for processing the plurality of images determine a change of illumination in sensor the region over time, the processing including:
registering the plurality of images to a common coordinate system based at least in part on odometry data characterizing the actor's traversal of the environment;
determining the change of illumination in the sensor region over time based on the registered plurality of images; and
a classifier for determining an object detection result based at least in part on the change of illumination in the sensor region over time.
